(19) United States
(12) Patent Application Publication
(10) Pub. No.: US 2019/0057560 A1
(43) Pub. Date: Feb. 21, 2019

(54) METHOD AND SYSTEM FOR PREDICTING WING ANTI-ICE FAILURE

(71) Applicant: THE BOEING COMPANY, Chicago, IL (US)

(72) Inventors: Seema Chopra, Bengaluru (IN); Franz D. Betz, Renton, WA (US)

(21) Appl. No.: 15/678,782

(22) Filed: Aug. 16, 2017

(51) Int. Cl. G07C 5/08; B64D 15/04

(52) U.S. Cl. CPC G07C 5/0808; B64D 15/04; G07C 5/0816; G07C 5/0841

(57) ABSTRACT

A system, and corresponding method, for predicting failure of aircraft wing anti ice valves includes a processor configured to receive sensor inputs from a plurality of components that have a synchronous or an anti-synchronous relationship. The sensor inputs indicate an operational characteristic of the components. Memory records historical data from the sensor inputs and the memory is communicatively connected to the processor. The processor compares the synchronous or anti-synchronous relationship of at least two components in the plurality of components and the processor calculates a tolerance for operation of the at least two components based on historical failure data. The processor identifies component operating times that exceed the tolerance and predicts failure of such a component based on the historical failure data.

### FIELD OF THE INVENTION

The disclosure is generally directed aircraft anti ice systems and more generally relates to methods and systems for predicting failure of anti ice valves in an aircraft anti ice system.

### BACKGROUND

Generally, aircraft rely on predictable air flow patterns over the wings and tail to generate lift. When these predictable air flow patterns are interrupted, the aircraft wing can lose lift, causing the aircraft to stall or otherwise affect controllability of the aircraft. Many different environmental factors can contribute to disruption of these predictable air flow patterns. One of the more significant environmental factors causing disruption is the accretion of ice on the airframe and wings when the aircraft flies through moisture at sufficiently cold temperatures to cause ice to form. To deal with this problem, aircraft anti ice and deice systems were developed.

Generally, there are two types of systems that deal with airframe icing. Anti ice systems prevent the formation of ice. Deice systems remove ice after it has formed. Some systems can perform both functions.

In large transport category aircraft, the most common anti ice system uses bleed air from the aircraft engines to heat certain portions of an aircraft structure (most often the leading edges of the wings, wing leading edge devices, and portions of the engines) by blowing the hot bleed air through or over the aircraft structures. Because engine bleed air is very hot and has a high pressure when being drawn off the engine compressor, a complex system of ducts and valves are needed to contain the bleed air and to direct the hot bleed air to the appropriate areas. These systems are embedded in the wing structure and are often difficult to access. When a valve in the anti ice system fails, the aircraft may be grounded until it can be repaired, causing a loss of revenue for an operator, such as an airline.

### SUMMARY

An example of a system for predicting component failure includes a processor configured to receive sensor inputs from a plurality of components that have a synchronous or an anti-synchronous relationship. The sensor inputs indicate one or more operational characteristics of the components. Memory records historical data from the sensor inputs and the memory is communicatively connected to the processor. The processor compares the synchronous or anti-synchronous operational relationship of at least two components in the plurality of components, based on the sensor inputs, and the processor calculates a tolerance for operation of the at least two components based on historical failure data. The processor identifies component operating times that exceed the tolerance and predicts failure of such a component based on the historical failure data.

Another example of a system for predicting failure of anti-ice valves in an aircraft includes a processor configured to receive pressure sensor inputs from an aircraft anti-ice system. The pressure sensor inputs indicate an operational characteristic of a wing anti-ice valve. A memory records historical data from the pressure sensor inputs and the memory is communicatively connected to the processor. The processor compares the pressure sensor inputs and calculates a tolerance for operation of at least two anti-ice valves based on historical failure data. The processor identifies operating times of the at least two anti-ice valves that exceed the tolerance and predicts failure of such valves based on the historical failure data.

An exemplary method of predicting failure of components in a system includes collecting historical operational data related to operation of a plurality of components that have a synchronous or an anti-synchronous operating relationship. The historical data is analyzed to identify operational tolerances that are predictive of imminent component failure. Components are identified that exceed the operational tolerances. A warning of impending failure is sent for the components that exceed the operational tolerances.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a schematic view of a system for predicting component failure that is constructed in accordance with the teachings of the disclosure.

FIG. 2 is a bottom perspective view of a wing of an aircraft including parts of the system of FIG. 1.

FIG. 3 is a perspective view of a wing anti ice valve of the wing of FIG. 2.

FIG. 4 is a logic diagram of a method of predicting component failure in accordance with the teachings of the disclosure.

### DETAILED DESCRIPTION

Turning now to FIG. 1, a system for predicting component failure 10 is schematically illustrated. The system for predicting component failure 10 in this illustrated embodiment is a system that predicts component failure in an aircraft anti ice system 20, in particular, in a Boeing 777 aircraft anti ice system.

The aircraft anti ice system includes a left anti ice duct 22 and a right anti ice duct 24 that run along the leading edge of a left wing 26 and a right wing 28 of an aircraft, respectively. A main bleed air duct 30 connects the left anti ice duct 22 and the right anti ice duct 24 to sources of bleed air. For example, the main bleed air duct 30 is connected to a left engine 38 through a left bleed air duct 32 and to a right engine 40 through a right bleed air duct 34. Similarly, the main bleed air duct 30 is connected to an auxiliary power unit (APU) bleed air duct 36 as an alternate source of bleed air.

Bleed air from the left engine 38 is directed to the left anti ice duct 22 through the main bleed air duct 30. Similarly, bleed air from the right engine 40 is directed to the right anti ice duct 24 through the main bleed air duct 30. Bleed air from an auxiliary power unit (APU) 42 is directed to either (or both) of the left anti ice duct 22 and the right anti ice duct 24 through the main bleed air duct 30.

Bleed air flow to the left anti ice duct 22 and to the right anti ice duct is controlled by a left anti ice valve 44 and a right anti ice valve 46, respectively. Bleed air flow from the left engine 38 into the main bleed air duct 30 is controlled by a left bleed air valve 48. Similarly, bleed air flow from the right engine 40 into the main bleed air duct 30 is controlled by a right bleed air valve 50. Again, similarly, bleed air flow from the APU 42 into the main bleed air duct 30 is controlled by an APU bleed air valve 43.

The left engine 38 is the primary source of bleed air to the left anti ice duct 22. The right engine 40 is the primary source of bleed air to the right anti ice duct 24. Bleed air from alternate sources to the left side of the bleed air system may be controlled by a left wing isolation valve 51. Similarly, bleed air from alternate sources to the right side of the bleed air system may be controlled by a right wing isolation valve 53. Engine bleed air from one engine may be used to supply both the left and right side of the bleed air system through an isolation valve 55.

A left anti ice pressure sensor 52 measures air pressure in the left anti ice duct 22. Similarly, a right anti ice pressure sensor 54 measures air pressure in the right anti ice duct 24. When the left anti ice valve 44 opens, permitting bleed air to flow into the left anti ice duct 22, pressure in the left anti ice duct 22 will rise. Similarly, when the right anti ice valve 46 opens, permitting bleed air to flow into the right anti ice duct 24, pressure in the right anti ice duct will rise. Similar effects occur with temperature in the left anti ice duct 22 and in the right anti ice duct 24.

A controller 56, such as an airfoil and cowl anti ice protection system (ACIPS) control card, sends electrical signals to the left anti ice valve 44 and to the right anti ice valve 46, causing the left anti ice valve 44 and the right anti ice valve 46 to open and close based on anti ice switch positions and ice detection sensors. The controller 56 receives electrical inputs from the left anti ice pressure sensor 52 and from the right anti ice pressure sensor 54. In other embodiments, the controller 56 may receive electrical inputs from a left anti ice temperature sensor and from a right anti ice temperature sensor (not shown, but could be substituted for, or in addition to, the left anti ice pressure sensor 52 and the right anti ice pressure sensor 54).

The controller 56 includes a processor 58 that is configured to receive sensor inputs from a plurality of components that have a synchronous or an anti-synchronous relationship, the sensor inputs indicating an operational characteristic of the components. In the illustrated embodiment, the processor receives the inputs from the left anti ice valve 44, from the right anti ice valve 46, from the left anti ice pressure sensor 52, and from the right anti ice pressure sensor 54. The controller 56 may also include a memory 60 for storing electronic instructions for operating the anti ice system 20. The memory 60 records historical data from the sensor inputs and the memory 60 is communicatively connected to the processor 58. In other embodiments, the processor 58 and the memory 60 may be located in other components that are communicatively connected to the controller 56, or in a computer that is remote from the aircraft, such as a ground computer.

Generally, the controller 56 instructs the left anti ice valve 44 and the right anti ice valve 46 to open or close simultaneously. The left anti ice valve 44 and the right anti ice valve 46 operate simultaneously to prevent an imbalance of bleed air between the left anti ice duct 22 and the right anti ice duct 24. An imbalance of bleed air between the left anti ice duct 22 and the right anti ice duct 24 could cause an uneven deice or anti ice operation, which could affect controllability of the aircraft.

The processor 58 compares the synchronous (or in other embodiments the anti-synchronous) relationship of at least two components. In the illustrated embodiment, the processor compares the synchronous relationship between the left anti ice valve 44 and the right anti ice valve 46, and the processor 58 calculates a tolerance for operation of the left anti ice valve 44 and the right anti ice valve 46, based on historical failure data that is recorded in the memory 60. In one preferred embodiment, the tolerance is 5 seconds or less. In another preferred embodiment, the tolerance is 1 second or less. When the left anti ice valve 44 operation differs from the right anti ice valve 46 operation by a time that exceeds the tolerance, the processor 58 sends a signal to the memory 60 that the tolerance has been exceeded. The processor 58 may also send an alarm or a notice to the airplane information management system (AIMS) 62 for transmission to a ground station and/or for download by maintenance personnel on the ground. In some embodiments, the AIMS 62 may be referred to as an airplane condition monitoring system (ACMS). Communication between the controller 56 and the AIMS 62, and between various other components described below, may be accomplished through a communication connection to a communication bus 64. The operation of the left anti ice valve 44 and the right anti ice valve 46 is determined by the left anti ice pressure sensor 52 and the right anti ice pressure sensor 54 sensing appropriate pressures for the commanded position of the left anti ice valve 44 and the right anti ice valve 46.

Other components communicatively connected to the bus 64 may include, but are not limited to, an overhead panel Aeronautical Radio, Incorporated (ARINC) system (OPAS) 66, a weight on wheels switch (WOW) 68, an air data inertial reference unit (ADIRU) 70, a left airfoil and cowl anti ice protection system (ACIPS) card 72, and a right ACIPS card 74. A left ice detector 76 may be communicatively connected to the left ACIPS card 72 and a right ice detector 78 may be communicatively connected to the right ACIPS card 74. An anti ice/lighting panel 80 may be communicatively connected to the OPAS 66.

While the sensor inputs in the illustrated embodiment are pressure sensor inputs from the left anti ice pressure sensor 52 and the right anti ice pressure sensor 54, in other embodiments other sensor inputs may be used. For example, a physical position detection on the left anti ice valve 44 and on the right anti ice valve 46 may be used. In yet other examples, temperature sensors may be substituted for, or used in addition to, the left and right pressure sensors. Examples of physical position sensors include, but are not limited to, Hall Effect sensors and solenoid sensors. In other embodiments, the sensor inputs may indicate other operational parameters of the components.

In some embodiments, the processor 58 is configured to perform rule association mining on the historical data, which may comprise quick access recorder (QAR) data.

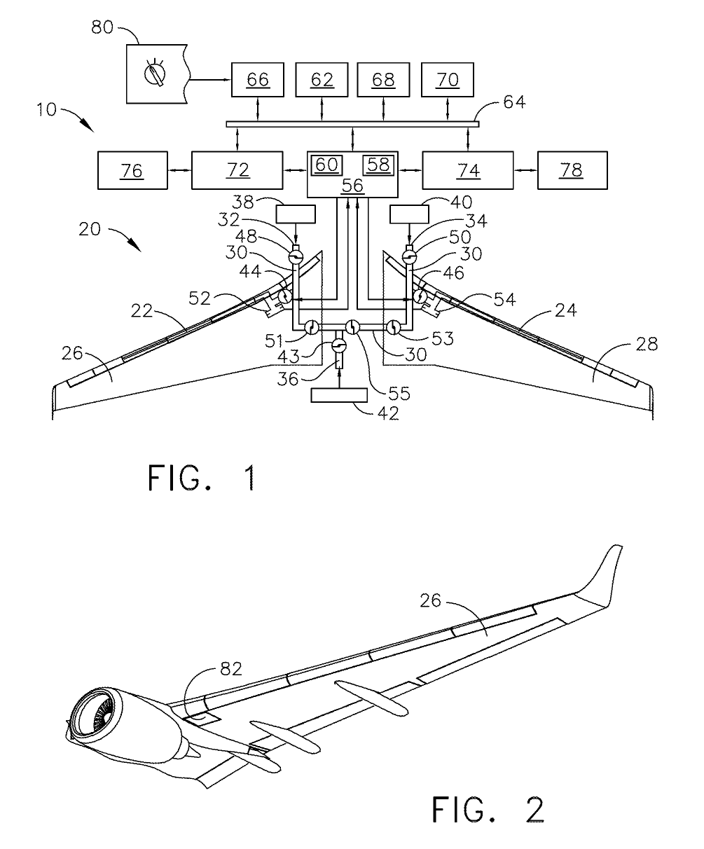

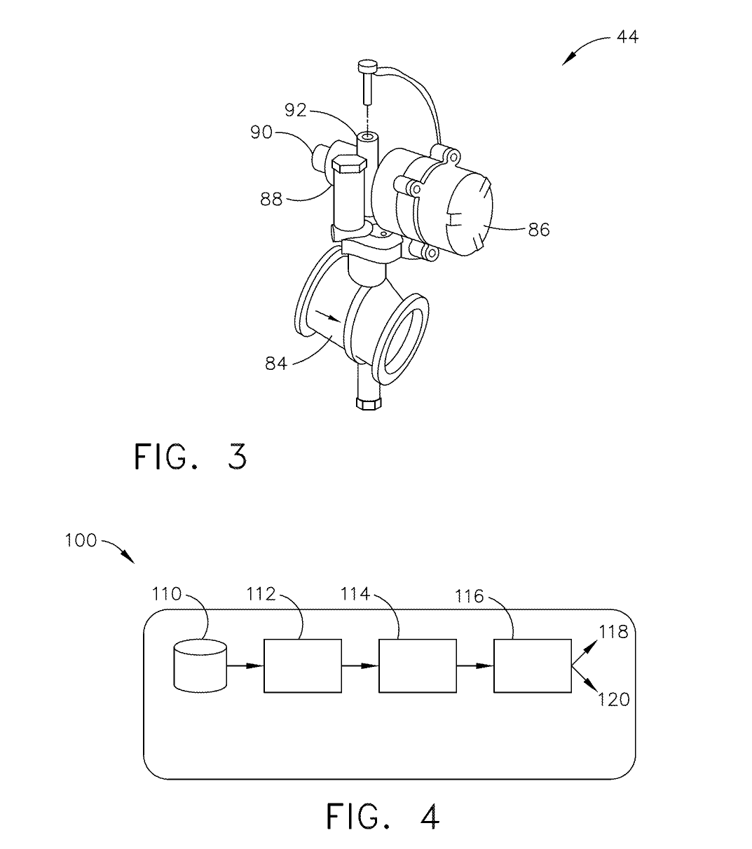

FIG. 2 illustrates the location of an anti ice valve access panel 82 on the underside of the left wing 26. The anti ice valve access panel 82 is removed to access the left anti ice valve 44 illustrated in FIG. 3. A similar anti ice valve access panel is located on the right wing, which is used to access the right anti ice valve (not shown).

The left anti ice valve 44 generally includes a valve body 84 that is connected to an actuator 86. The actuator 86 drives a torque motor 88, which moves a control element (not shown) within the valve body 84. An electrical connector 90 is communicatively connected to the controller 56 (FIG. 1) and the electrical connector 90 carriers a control signal from the controller 56 to the actuator 86 to operate the left anti ice valve 44. A locking pin and position indicator 92 are also included for visual inspections of the left anti ice valve 44 and for maintenance use.

Turning now to FIG. 4, an exemplary method of predicting failure of components in a system is illustrated. In the following method, any operation that is described as being performed by the controller 56 may be performed by any processor and memory, located locally on the aircraft, or located remote from the aircraft. For example, the operations may be performed by a processor and a memory on a ground computer that accesses the appropriate data, or in a processor and a memory located in another aircraft system.

The method 100 comprises collecting historical operational data from QAR data 110. The QAR data 110 is related to operation of a plurality of components that have a synchronous or an anti-synchronous operating relationship. In the illustrated embodiment, the QAR data 110 is related to operational parameters of an anti ice system on a Boeing 777 aircraft. More particularly, the QAR data 110 is related to the synchronous operation of the left anti ice valve 44 and the right anti ice valve 46.

The processor 58 analyzes the historical data at 112-116 to identify operational tolerances that are predictive of imminent component failure, to identify components that exceed the operational tolerances, and to send a warning of impending failure for the components that exceed the operational tolerances.

More specifically, at 112, the processor 58 explores the data and preprocesses the historical data if needed. The historical data explored includes data from all phases of flight.

At 114, the processor 58 filters and correlates the historical data. The historical data may be related to a plurality of components that operate in a synchronous or anti-synchronous manner. The historical data may be more specifically related to sensors in an aircraft anti ice system, and event more specifically to pressure sensors in an aircraft anti ice system. The processor 58 also identifies critical features/sensors using feature selection.

At 116, the processor 58 applies association rule mining to compute an operational tolerance for completion of synchronous or anti-synchronous component operation. More specifically, the processor 58 uses association rule mining to determine operational tolerances of components of an anti ice system that predict imminent (within the next 20-50 flights) failure of a component. In some embodiments, the operational tolerance is completion of the operation in less than 1 second. The processor 58 identifies occurring failure patterns in the historical data and formulates rules that predict the imminent failure of components.

At 118, the processor 58 detects operational parameters of system components that exceed the calculated operational tolerance and at 120 predicts the failure of such system components and sends a warning of imminent failure.

While various embodiments have been described above, this disclosure is not intended to be limited thereto. Variations can be made to the disclosed embodiments that are still within the scope of the appended claims.

What is claimed is:

1. A system for predicting component failure, the system comprising:
a processor configured to receive sensor inputs from a plurality of components that have a synchronous or an anti-synchronous relationship, the sensor inputs indicating an operational characteristic of the plurality of components; and
a memory for recording historical data from the sensor inputs, the memory being communicatively connected to the processor,
wherein the processor compares the synchronous or anti-synchronous relationship of at least two components in the plurality of components and the processor calculates a tolerance for operation of the at least two components based on historical failure data, and the processor identifies component operating times that exceed the tolerance.

2. The system of claim 1, wherein the at least two components comprise wing anti-ice valves.

3. The system of claim 1, wherein the sensor inputs indicate operational parameters of the at least two components.

4. The system of claim 3, wherein the sensor inputs are pressure sensor inputs.

5. The system of claim 1, wherein the system is installed on an aircraft.

6. The system of claim 5, wherein the aircraft is a commercial airplane.

7. The system of claim 5, wherein the processor sends warning of impending failure when a tolerance is exceeded.

8. The system of claim 7, wherein the processor sends the warning through an airplane condition monitoring system (ACMS).

9. A system for predicting failure of anti-ice valves in an aircraft, the system comprising:
a processor configured to receive pressure sensor inputs from an aircraft anti-ice system, the pressure sensor inputs indicating an operational characteristic of a wing anti-ice valve; and
a memory for recording historical data from the pressure sensor inputs, the memory being communicatively connected to the processor,
wherein the processor compares the pressure sensor inputs and calculates a tolerance for operation of at least two anti-ice valves based on historical failure data, and the processor identifies operating times of the at least two anti-ice valves that exceed the tolerance.

10. The system of claim 9, wherein the processor is configured to perform rule association mining on the historical data.

11. The system of claim 9, wherein the historical data comprises quick access recorder (QAR) data from the aircraft.

12. The system of claim 9, wherein the tolerance is one second.

13. The system of claim 9, wherein the processor is further configured to send a warning of impending failure by an aircraft ACMS report when one of the anti-ice valves exceeds the tolerance.

14. The system of claim 9, wherein the anti-ice valves are part of a commercial airplane wing-anti ice system.

15. A method of predicting failure of components in a system, the method comprising:
collecting historical data related to an operation of a plurality of components that have a synchronous or an anti-synchronous operating relationship;
analyzing the historical data to identify operational tolerances that are predictive of imminent component failure;
identifying components of the plurality of components that exceed the operational tolerances; and
sending a warning of impending failure for the components that exceed the operational tolerances.

16. The method of claim 15, wherein the plurality of components comprise wing anti-ice valves for an aircraft.

17. The method of claim 16, wherein the historical data comprises pressure data from a plurality of pressure sensors.

18. The method of claim 17, wherein the operational tolerances are completion of the operation in less than 1 second.

19. The method of claim 15, wherein the historical data is QAR data from an aircraft.

20. The method of claim 15, wherein the analyzing of historical data includes rule association mining.
